(19) United States
(12) Patent Application Publication
(10) Pub. No.: US 2015/0066800 A1
(43) Pub. Date: Mar. 5, 2015

(54) TURBO BATCH LOADING AND MONITORING OF DOCUMENTS FOR ENTERPRISE WORKFLOW APPLICATIONS

(71) Applicant: BANK OF AMERICA CORPORATION, Charlotte, NC (US)

(72) Inventors: Charles Milan Hawes, III, Indian Trail, NC (US); John Henry Maas, Charlotte, NC (US); Steven A. Walker, North Salt Lake, UT (US)

(73) Assignee: BANK OF AMERICA CORPORATION, Charlotte, NC (US)

(21) Appl. No.: 14/013,886

(22) Filed: Aug. 29, 2013

(51) Int. Cl. G06Q 10/06

(52) U.S. Cl. CPC G06Q 10/06
USPC 705/342

(57) ABSTRACT

Embodiments of the invention are directed to a system, method, or computer program product for providing customer document indexing and presentment for expedited loading, inserting, updating, and presenting documents within a database framework. The documents include customer documents based on customer interaction with the entity. Specifically, the invention receives electronic documents from sources within the entity. The invention expedites the loading/inserting of large quantities of documents to database tables for storage. Initially received data for loading is processed, via partitioning, onto temporary tables. The documents are staged and subsequently pointed to a destination base table for storage. In this way, a massive amount of data loading from the temporary table to a base table may occur. Once loaded, notification of the documents availability for customer access is then provided to the customer. The documents are then either sent to the customer or accessible by the customer via application.

### BACKGROUND

Traditionally, financial statements from financial institutions are mailed to the customers. These statements provide customers with important information about the customers' financial accounts. More recently, with the advent of online banking, some financial institutions have provided an option for customers to receive statements via the online banking platform.

Information technology infrastructures for entities providing these statements usually require several operating environments, vendor resource deployment, authentication repositories and mechanisms, application servers, and databases for storing, indexing, and updating massive amounts of data on a daily bases. All of these systems and processes must work together in order to operate a large entity's information technology and be able to store, index, and manage data received by the entity and statements to be sent to customers.

The process storing data or database loading and updating takes time, central processing units (CPU) away from the infrastructure, logging time, and in some cases has redundancies and locking issues associated with the process.

Therefore, a need exists for an improved statement input and presentment system that limits the time, memory, and logging required for core statement input, update, and presentment functions to be completed and implemented.

### BRIEF SUMMARY

The following presents a simplified summary of all embodiments in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of all embodiments in a simplified form as a prelude to the more detailed description that is presented later.

Embodiments of the present invention address the above needs and/or achieve other advantages by providing apparatus (e.g., a system, computer program product, and/or other devices) and methods for providing customer document indexing and presentment system for expedited loading, indexing, updating, and presenting documents within a database framework. The documents are associated with customer interactions with the entity. Furthermore, the documents for loading, indexing, updating, and presenting are from one or more various groups within an entity. Furthermore the system reduces the central processing units (CPU) required for the process of the documents as well as limiting logging time and locking issues associated with traditional loading and updating processes.

In some embodiments, the system may receive documents from several sources within an entity. In this way, the system may receive customer documents for loading, indexing, updating, and presenting to a customer from five or more sources within the entity. The system may receive 300 million or more documents in a given day. The documents may be received from a single source or multiple sources. As such, the invention must load, index, update, and present high volumes of documents within a given time frame in order to keep up with the volume of documents received from the sources. Furthermore, because of the multiple sources of each of these documents, many of them may have the same file name associated therewith.

In some embodiments, the invention will add a time stamp to each file received. The time stamp will be added to the end of the file name for the document or set of documents. In some embodiments, the documents will be stamped and loaded in the order they are received. As such, the loading and saving will occur in order of received documents. The time stamp further identifies the file and the documents within the file. Specifically, this is utilized when one or more documents are received from the same group or source with the same file name. Therefore distinguishing the document from the other documents received and stored.

Once received, the documents and data associated with the documents need to be stored by the entity. In some embodiments, the data associated with the documents (including an electronic version of the document) may be stored in tables, such as those in relational databases and flat file databases. These tables include sets of data values that are organized into columns and rows. Tables typically have a specified number of columns, but rows may vary. Each row may be identified by the values appearing in a particular column subset with may be identified as a unique key index. In this way, the tables may provide for indexing of data that is searchable and accessible to any individual within the entity.

In some embodiments, the invention provides expedited loading of the documents in order to be stored by an entity such as a financial institution. Typically, these documents are loaded into destination tables in a single load process or in a parallel process. However, single process and parallel processes of loading data directly to a destination table requires logging by the database system, locks held on the destination table, and the like that result in delays or lags, from the initial receipt of data until the data is indexed and searchable by users within an entity.

As such, the invention provides an improved destination table insertion. Such that data may be loaded onto a destination table quickly, without lag time. In some embodiments, in order to load large quantities of documents into the appropriate table, such as over 100 million data loads per day, the documents may be loaded on global temporary tables to stage for loading onto a destination table. Global temporary tables or in-memory database tables (such as DB2 tables or the like) may be visible to all individuals across an entity, but the data within the table may be visible to all of the individuals across the entity or only to the creator that inserted the table.

In some embodiments, loading the documents onto a global temporary table may be done by partitioning. In this way, the global temporary table may be loaded with documents at different partitions within the same table. This loading of different partitions may be done simultaneously within the same table. As such, not only is one or more global temporary tables being loaded with documents at a given time, those tables may be loaded at two or more separate partitioned locations within the table.

The documents may be associated in partitioned rows to be inserted onto the global temporary table. These rows are subsequently processed in groups of units of works. A row, or record or tuple, may represent a single, implicitly structured data. Each row may represent a set of related data, the relation determined by the entity. The relationship may be associated with where the document originated, the type of document, user associated with the document, time stamp of the file, the date of the data entry/storage, the business unit within the entity associated with the data, the source of the data, and/or any other relationship that may be determined by the entity. Typically, each row within the table will have a similar structure.

Once the entire unit of work is staged and validated, a final insert may be issued to move the contents of the global temporary table to the destination base table. In some embodiments, this may be done using a Structured Query Language (SQL) statement issuing the manipulation of the contents of the global temporary table to the proper destination base table.

In some embodiments, the invention provides error check and resolution. Specifically, if a Referential Integrity (RI) error occurs during the final insert, than a series of update statements are used to resolve the error and the final insert statement is re-issued.

Next, the unit of work are successfully processed, such that all of the data from the global temporary table is inserted and in rows on the destination base table, the rows of data created on the global temporary table are deleted in mass. A check point restart record is then written and a commit is issued ending the process. This process may be repeated until all the data that needs to be inputted onto a base table for indexing or the like has been processed and is loaded.

In some embodiments, the invention provides business activity monitoring throughout the process of receiving documents to final loading on a destination base table. This way the monitoring system is able to reconcile the counts from an end-to-end perspective to ensure that there are no unknown fallout of records during any of the process. The business activity monitoring provides error check and resolution. Specifically, error check and resolution checks for mistakes in the loaded documents, elimination of repeats, confirm proper documents to be updated, confirm time stamps of the file, and the like. In this way, while a high volume of data may be updated daily, this error check ensures that the appropriate data is being updated and correctly processed for indexing.

In some embodiments, the system provides expedited updating of documents stored by the financial institution. The documents may be stored in tables, such as those in relational databases and flat file databases. These tables include sets of data values that are organized into columns and rows. Tables typically have a specified number of columns, but rows may vary. Each row may be identified by the values appearing in a particular column subset with may be identified as a unique key index. In this way, the tables may provide for indexing of data that is searchable and accessible to any individual within the entity.

Next, once all of the documents and/or updates from the global temporary table are inserted and in rows on the appropriate destination base table, the rows of update data created on the global temporary table are deleted in mass. A check point restart record is then written and a commit is issued ending the process. This process may be repeated until all the update data that needs to be inputted onto a base table for indexing or the like has been processed and is loaded.

In some embodiments, once the documents are stored on the destination database, the user may have access to his/her documents for viewing. In some embodiments, prior to providing the documents for user view, the system may provide the user with an indication of when the document will be available for review. Furthermore, the system may allow the user to request documents be available for review. If a user requests a document that is not yet stored, the system may expedite the loading and presentment of that document.

In some embodiments, once the system loads the document onto the destination database the user may have access to his/her document. In this way, the system may send a notification to the user that the document is available for viewing. In some embodiments, the document may be sent to the user directly via his/her email or the like. In other embodiments, the document may be presented to a user via his/her online banking application. In this way, once the document is loaded the document may be transferred through the entity's mainframe in order to be communicated to the user.

In some embodiments, the system has the ability to hide or unhide documents or files from users. In this way, after a document is loaded onto the destination base table, the system may determine to hide the document or file from the users. As such, the documents may be stored, but not available for the user to view. In other embodiments, the system may further hide documents or files that were previously viewable by a user. In this way, if the document is out of date, needs updating, is inaccurate, or the like, the system may be able to store the document but subsequently hide the document from view. Furthermore, in some embodiments, once a document is hidden from user view, the system may unhide the document as well. As such, the system may subsequently unhide a previously hidden document such that the user may be able to view the document again after it has been unhidden.

Embodiments of the invention relate to systems, methods, and computer program products for user document indexing and presentment, the invention comprising: receiving documents for storage on the entity database, wherein the documents are received from a source within the entity, wherein the documents are created by the source based on an interaction between the entity and the user; presenting a temporary table to store the received documents; inserting the received documents onto the temporary table, wherein the insertion of the received data is done by partition insertion; staging the temporary table comprising the received documents; inserting the received documents from the temporary table to an appropriate base table, wherein the insertion of all the documents on the temporary table is completed using a single insert statement; identifying the user associated with each of the documents inserted on the appropriate base table; and notifying the user associated with each of the documents inserted on the appropriate base table that the documents have been inserted on the appropriate base table.

In some embodiments, the invention further comprises presenting one or more documents associated with the user to the user, wherein presenting the one or more documents comprises electronically communicating the document to the user or providing the one or more documents to an online banking application associated with the user.

In some embodiments, the invention further comprises confirming providing activity monitoring, wherein the activity monitoring monitors to ensure that the received documents are inserted correctly on the appropriate base table.

In some embodiments, the invention further comprises deleting, in mass, the received documents from the temporary table based at least in part on the confirming that the received documents are inserted correctly on the appropriate base table.

In some embodiments, the documents are generated by sources within the entity for presentment to the user, wherein the documents are generated based at least in part on financial institution accounts corresponding to the user that the entity maintains.

In some embodiments, partition insertion further comprises inserting one or more batches of documents into the temporary table at the same time.

In some embodiments, the temporary table is a global temporary table or in-memory database table that is internal to the entity, wherein the temporary table is created at an initiation of receiving documents to insert on a base table within the entity database, wherein the temporary table is not logged by the entity database.

In some embodiments, inserting the received documents from the temporary table to the appropriate base table further comprises inserting the received documents to the appropriate base table in mass, wherein the mass data insert reduces locking contentions.

In some embodiments, the invention further comprises hiding the documents inserted on the appropriate base table from the user, wherein hiding the documents comprises not allowing the user to view the documents, wherein the hiding is reversible.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 provides a high level process flow illustrating the process of customer document indexing and presentment, in accordance with embodiments of the invention;

FIG. 2 provides a high level process flow illustrating the process of loading documents for enterprise workflow applications, in accordance with embodiments of the invention;

FIG. 3 provides an illustration of a customer document indexing and presentment system environment, in accordance with various embodiments of the invention;

FIG. 4 provides an illustration of a data flow through the system for loading and updating documents, in accordance with an embodiment of the invention;

FIG. 5 provides an illustration of partition loading of document for enterprise workflow applications, in accordance with embodiments of the invention;

FIG. 6 provides a detailed decision process flow illustrating the process of document loading for enterprise workflow applications, in accordance with embodiments of the invention;

FIG. 7 provides a detailed process illustrating the process of updating documents for enterprise workflow applications, in accordance with embodiments of the invention;

FIG. 8 provides a high level process flow illustrating the presentment of documents to a user, in accordance with embodiments of the invention; and

FIG. 9 provides a high level decision process flow illustrates a user request for documents, in accordance with embodiments of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

Furthermore, embodiments of the present invention use the term “user” or “customer.” It will be appreciated by someone with ordinary skill in the art that the user may be an individual, financial institution, corporation, or other entity that may have documents associated with accounts, transactions, or the like with the entity providing the system.

The term “document” or “documents” as used herein may refer to an electronic version of any documents, notices, statements, receipts, bills, or the like an entity may generate in association with a customer. In preferred embodiments a document may be generated by a financial institution, these documents may include one or more of an account statement, deposit, image of transaction, check image, mortgage documents, or other financial institution generated documents.

Although some embodiments of the invention herein are generally described as involving a “financial institution,” one of ordinary skill in the art will appreciate that other embodiments of the invention may involve other businesses that take the place of or work in conjunction with the financial institution to perform one or more of the processes or steps described herein as being performed by a financial institution. Still in other embodiments of the invention the financial institution described herein may be replaced with other types of entities that have electronic document or data storage needs.

In accordance with embodiments of the invention, the term “information technology” as used herein refers to the totality of interconnecting hardware and software that supports the flow and processing of information. Information technology include all information technology resources, physical components, and the like that make up the computing, internet communications, networking, transmission media, or the like of an entity.

Typically, documents are sent by mail to each of the customer's from an individual source within an entity, such as a financial institution. For example, a group managing a customer's checking account may send the customer, via mail, a document associated with that customer's checking account, while a group managing the customer's savings account may send the customer, via mail, a document associated with the balance of the customer's savings account.

Prior to the customer document indexing and presentment system entities were continually backlogged loading and indexing documents for storage on a database. For example, when an entity receives large quantities of documents from various sources in a single day (or within a relatively short time frame) it is unable to load and index the documents in a timely manner.

In typical enterprise componentized workflow applications requiring entities to load large amounts of data into tables, such as over 100 million data loads per day, parallel processes are being utilized. As such, loading several data loads into different destination tables at one time. In this way, multiple loading processes may be occurring simultaneously within an entity in order to load data onto the appropriate destination table. Furthermore, while loading, a typical database system places a lock on the base table that is being loaded. In this way, until the data is loaded onto the base table, the table and potentially other pages are locked until a commitment is issued. In this way, the database system may lock pages do to the amount of data being manipulated, thus providing locking contentions.

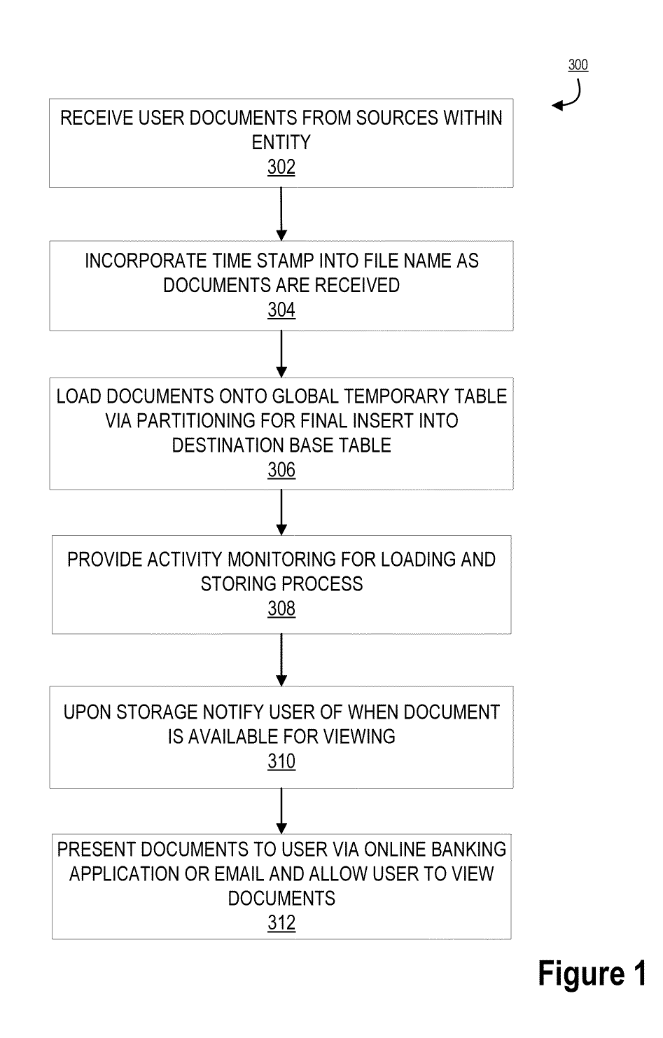

FIG. 1 provides a high level process flow illustrating the process of customer document indexing and presentment 300, in accordance with embodiments of the invention. As illustrated in block 302 the system may receive user documents from various sources within the entity. As described above, user documents may be one or more documents, notices, statements, receipts, bills, or the like an entity may generate for a user. A user may be any person, entity, business, or the like that interacts with the entity such that the entity may have one or more documents associated with that user. For example, a user may be a customer of a financial institution. The user may have a savings account, credit card, and checking account with the financial institution. As such, the financial institution may generate documents for each of the accounts the user has with the financial institution. Furthermore, each of these documents may be generated from different sources within the financial institution. For example, group may generate and be the source of the user documents associated with the checking account while a different group may generate and be the source of the user documents associated with the credit card account.

Once the system receives the user documents from the various sources within the financial institution, the system will incorporate a time stamp onto the file name of the documents received, as illustrated in block 304. In this way, the time stamp will be added to the end of the file name for the document or documents. In some embodiments, the documents will be stamped and loaded in the order they are received. As such, the loading and saving will occur in order of received documents. The time stamp further identifies the file and the documents associated therein. Specifically, this is utilized when one or more documents are received from the same group or source with the same file name. Therefore distinguishing the document from the other documents received and stored. As such, making each document received in block 302 unique in file name, irrespective of the file name of the document originally received from the source.

Once the documents have been received in block 302 and a unique time stamp has been added to the file name in block 304, the system may load documents onto global temporary tables via partitioning, as illustrated in block 306. Loading the documents onto a global temporary table may be done by partitioning. Subsequently, the documents on the global temporary table may be inserted as a whole into the destination base table. Utilizing partitioning, the global temporary table may be loaded with documents at different partitions within the same table. This loading of different partitions may be done simultaneously within the same table. As such, not only is one or more global temporary tables being loaded with documents at a given time, those tables may be loaded at two or more separate partitioned locations within the table. Subsequently, the data on the global temporary tables, once loaded, will be loaded onto a destination table with a database for storage for the entity.

During the entire process of receiving, loading, and indexing (both on the global temporary table and the destination table) the system may maintain active monitoring of each step within the process, as illustrated in block 308. As such, this way the monitoring is able to reconcile the counts from an end-to-end perspective to ensure that there are no unknown fallout of records during any of the process. The business activity monitoring provides error check and resolution. Specifically, error check and resolution checks for mistakes in the loaded documents, elimination of repeats, confirm proper documents to be updated, confirm time stamps associated with the files, and the like. In this way, while a high volume of data may be updated daily, this error check ensures that the appropriate data is being updated and correctly processed for indexing.

As illustrated in block 310, upon storage of the documents on the destination table, the system may notify the user that the user document is not available for viewing. As such, once the documents are stored on the destination table, the user may have access to his/her documents for viewing. The system may present the documents the user via online banking application or email. Therefore allowing the user to view the documents loaded, as illustrated in block 312.

In some embodiments, the system may hide the stored documents. In this way, the user may not be able to visualize the stored documents. In some embodiments, documents that are available for user view may subsequently be hidden by the system. In this way, the invention may allow for the hiding the documents at any point, such that the user may not be able to view the documents. In some embodiments, the invention may further allow for un-hiding the documents. In this way, previously hidden documents may be subsequently viewed by the user.

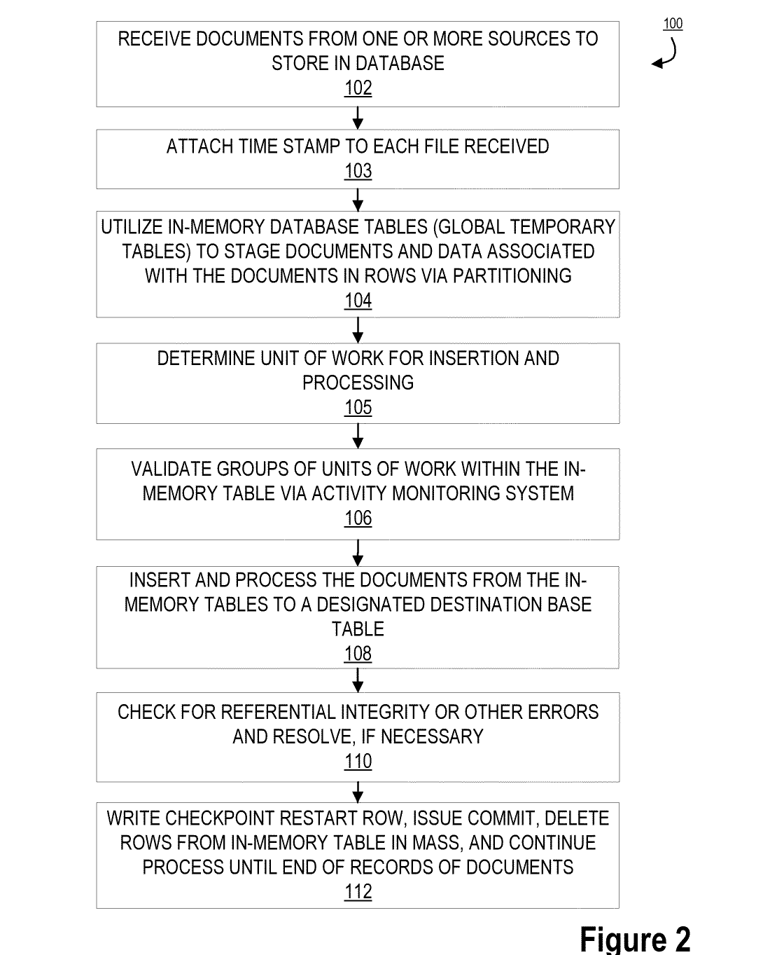

FIG. 2 illustrates a high level process flow for the process of loading documents for enterprise workflow applications 100, in accordance with embodiments of the invention. As illustrated in block 102 of the high level process flow 100, the system may receive documents from one or more sources within the entity to store in the database. The documents may be from sources within the entity, such as a line of business, group or the like. The documents may also be from a user, vendor, or the like. For example, the documents may one or more electronic versions of documents, notices, statements, receipts, bills, or the like an entity may generate for a user. However, documents may also include information associated with that document including programming notes, instructions, output resulting from the use of any software program, including word processing documents, spreadsheets, database files, charts, graphs and outlines, electronic mail or “e-mail,” personal digital assistant (“PDA”) messages, instant messenger messages, source code of all types, programming languages, linkers and compilers, peripheral drives, PDF files, accounts, identification numbers, PRF files, batch files, ASCII files, crosswalks, code keys, pull down tables, logs, file layouts and any and all miscellaneous files or file fragments, deleted file or file fragment.

As illustrated in block 103, the invention will attach a time stamp to the file name associated with one or more document received in block 102. As such, when one source sends large quantities of documents with the same file name, the system will attach a time stamp to each file received (as it is received). This way, each document will have a unique file name associated with it.

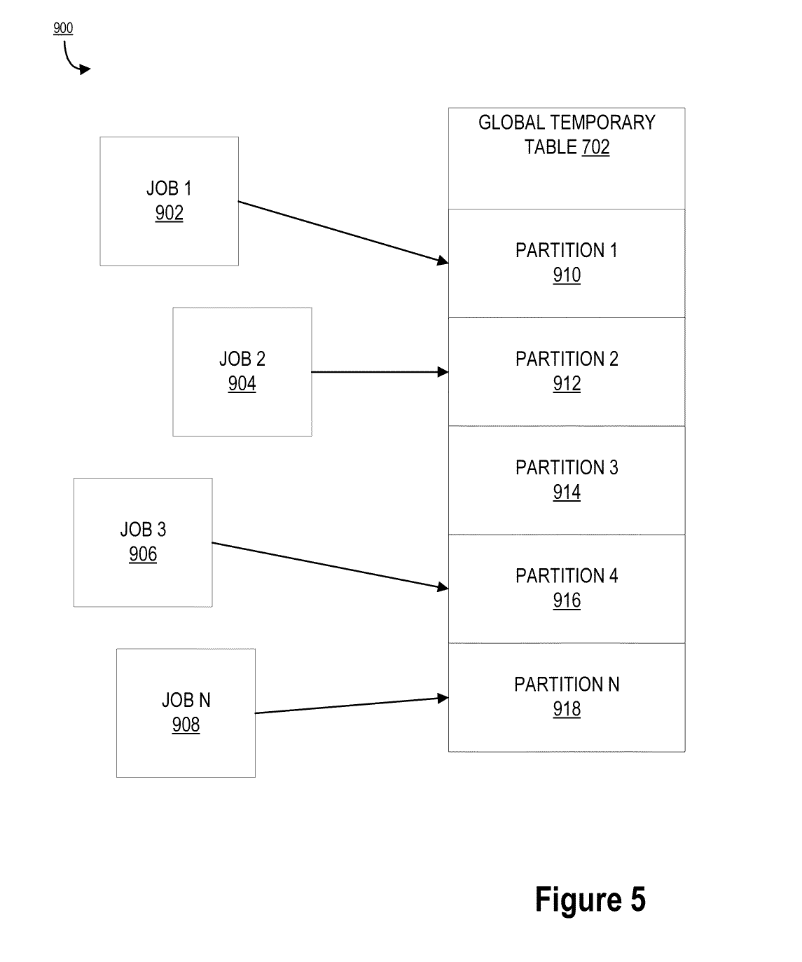

Next, as illustrated in block 104 the invention utilizes in-memory database tables (or global temporary tables) to stage the documents to be stored in the database. The inserting of documents into the global temporary table is done via partitioning. Partitioning, which is further detailed below with respect to FIG. 5, allows the system to load documents in multiple locations within the same table at the same time. In some embodiment multiple rows are used within a table. A global temporary table may be a table that is visible to all sessions but the data in the table is only visible to the session that inserts the data into the table. In some embodiments, the entity may be able to set the amount of rows or a multiple amount of rows associated with the global temporary table. In other embodiments, the system determines the number of rows based on the amount of data received to store in the database for indexing on a destination base table. In some embodiments, the global temporary table may also have an index created with the table.

Next, as illustrated in block 105, the rows that are to be inserted are grouped into units of work for insertion and processing into the destination base table. Once the units of work have been established, the system validates, using the activity monitoring system, the groups of units of work within the global temporary table, as illustrated in block 106. In this way, multiple rows of documents may be validated within the temporary table before ever being uploaded and indexed at the base, long term storage table.

Once validated, the system may insert and process the received documents from the global temporary table to a designated destination based table, as illustrated in block 108. The designated base table may be one or more tables in which the system, entity, or the like may have selected for long term storage and indexing. In some embodiments, the designated base table may be one or more tables in which the documents, based on the type of document, designates the designated base table, or the like.

As illustrated in block 110, once the received data is inserted and processed from the global temporary table to the designated base table, the activity monitoring system continues to checks for referential integrity errors or other errors associated with either the received documents or errors associated with the transfer of the documents to the global temporary table and/or transfer from the global temporary table to the designated base table. Because of the mass amount of data associated with uploading of documents to the designated base table, the system may continually check for errors associated with the same.

Finally, as illustrated in block 112, the system writes a checkpoint restart row, issues a commit. The system then deletes the documents on the global temporary table in mass upon the successful inserting and processing of all of the data rows from the global temporary table to the designated base table. Then, the process may be continued until the end of the records file.

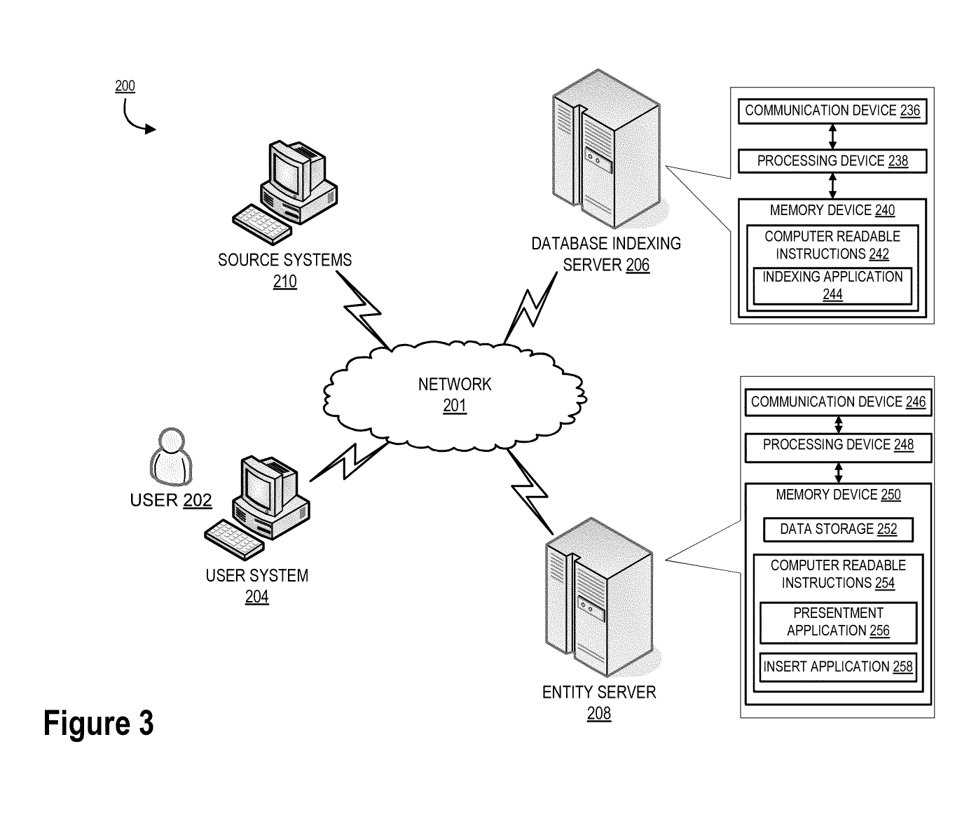

FIG. 3 illustrates a high level process flow for the customer document indexing and presentment system environment 200, in accordance with various embodiments of the invention. As illustrated in FIG. 3, the entity server 208 is operatively coupled, via a network 201 to the user system 204, the database indexing system 206, and the source system 210. In this way, the entity server 208 can send information to and receive information from the user system 204, database indexing server 206, and the source systems 210 to provide for user document indexing and presentment.

FIG. 3 illustrates only one example of an embodiment of a customer document indexing and presentment system environment 200, and it will be appreciated that in other embodiments one or more of the systems, devices, or servers may be combined into a single system, device, or server, or be made up of multiple systems, devices, or servers.

The network 201 may be a global area network (GAN), such as the Internet, a wide area network (WAN), a local area network (LAN), or any other type of network or combination of networks. The network 201 may provide for wireline, wireless, or a combination wireline and wireless communication between devices on the network.

In some embodiments, the user 202 is an individual that an affiliation with the entity generating the documents. In this way, the user 202 may be a customer, vendor, or the like of the entity. As such, the entity may, based on the user's relationship with the entity generate one or more documents for the user 202. In some embodiments, the user 202 may be an individual or business with a relationship with a financial institution. In this way, the financial institution may generate one or more financial statements, notes, receipts, or the like based on the user's relationship with the financial institution. In this way, multiple individuals or entities may comprise a user 202 such that the entity may generate one or more documents for each of the user's where these documents may require the entity to store for a long term. In some embodiments, the data may be required to be stored based on regulations, based on a line needs, legal concerns, customer needs, user 202 requests, or the like. In some embodiments the data may be financial institution or financial account data associated with a customer of the entity. In this way, in other embodiments, the user 202 may be an individual customer of the entity.

As illustrated in FIG. 3, the entity server 208 may include a communication device 246, processing device 248, and a memory device 250. The processing device 248 is operatively coupled to the communication device 246 and the memory device 250. As used herein, the term “processing device” generally includes circuitry used for implementing the communication and/or logic functions of the particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device may include functionality to operate one or more software programs based on computer-readable instructions thereof, which may be stored in a memory device. The processing device 238 uses the communication device 246 to communicate with the network 201 and other devices on the network 201, such as, but not limited to the user system 204, source system 210, and/or database indexing server 206 over a network 201. As such, the communication device 246 generally comprises a modem, server, or other device for communicating with other devices on the network 201.

As further illustrated in FIG. 3, the entity server 208 comprises computer-readable instructions 254 stored in the memory device 250, which in one embodiment includes the computer-readable instructions 254 of an insert application 258. In some embodiments, the memory device 250 includes data storage 252 for storing data related to the insert application 258 including but not limited to data created and/or used by the insert application 258. In some embodiments, the entity server 208 comprises computer-readable instructions 254 stored in the memory device 250, which in one embodiment includes the computer-readable instructions 254 of a presentment application 256. In some embodiments, the memory device 250 includes data storage 252 for storing data related to the presentment application 256 including but not limited to data created and/or used by the presentment application 256.

In the embodiments illustrated in FIG. 3 and described throughout much of this specification, the insert application 258 allows for the receiving and inserting of user documents for storage on databases for enterprise workflow applications. The insert application 258 provides for database document insertion for enterprise workflow applications by receiving documents for insertion, applying time stamps to the document files, requesting or creating new global temporary tables for the received documents, stage the data for insertion to a base table by inserting load documents onto the created global temporary table via partitioning, validate the insertion documents on a global temporary table, insert and process the documents from the global temporary table to a selected base table, check for errors, delete the documents from the global temporary table, and issuing a new restart record for the process.

In some embodiments, the insert application 258 receives documents from one or more sources for insertion into a base table for database storage, for long term indexing with the ability for a user 202 to have access to and search for the documents associated with that user 202 at a later date. The documents may be received via the network 201 from one or more source systems 210. In some embodiments, the source systems 210 may be within the entity providing the storage. In other embodiments, the source systems 210 may be external systems. Typically, the documents may be received in any of a variety of formats. The insert application 258 may take the received documents and convert it to the appropriate format for subsequent long term database storage on a base table. In some embodiments, this format may be any readable information technology format such as text, image, zipped data, SQL, or another computer readable format for storage.

In some embodiments, the insert application 258 may apply a time stamp to each file as it is received from the source system 210. As such, each document will have a unique file name with a time stamp that is different from each of the other documents received, no matter the quantity of documents received at any given time. The time stamp may have one or more of the date (including year, month, and day), hour, minute, second, tenth of second, hundredth of a second, and/or thousandth of a second, which will make each document have a unique file name.

In some embodiments, the insert application 258 may request or create new global temporary tables for the received documents. As such, the insert application 258 may receive the documents for insertion and utilize partitioning insert to add the documents to a global temporary table prior to inserting all of the documents onto the base table. In some embodiments, the insert application 258 may create a new global temporary table for insertion. In other embodiments, the insert application 258 may receive a new global temporary table from the database indexing server 206 or other system associated with the network 201.

In some embodiments, the insert application 258 may then stage the data for insertion into the base table on the newly created or received global temporary table. Inserting the data onto the global temporary table may be done via partitioning using multi-row inserts. In this way, in some embodiments multiple rows may be inserted on the global temporary table at a single time at different partitioned portions of the table, as illustrated in further detail below with respect to FIG. 5. In other embodiments, a single row may be inserted on the global temporary table at a single time. In yet other embodiments, a single data unit may be inserted on the global temporary table at a single time. In this way, the insert application 258 uses computer readable instructions 254 to insert documents, whether a single unit, single row, partitioned, or multi-row, to insert data onto the global temporary table to stage the documents for mass insertion into a destination base table. In some embodiments, the global temporary table, while data is being inserted, may be stored within the data storage 252 of the entity server 208.

Next, the insert application 258, utilizing the activity monitoring system, may validate the inserted documents on the global temporary table. In this way, the insert application 258 may review the received documents for insertion and make sure there are no redundancies, inconsistencies, or format issues associated with the documents loaded on the global temporary table.

The insert application 258 may then insert and process the documents from the global temporary table to a selected destination base table. As such, the insert application 258 commands an insert into/select from SQL statement to move the contents of the global temporary table to the appropriate base table. The appropriate base table may be located within the database indexing server 206. The entity may determine the appropriate base table for loading. Furthermore, in some embodiments, the data is inserted in mass from the global temporary table to the base table. In this way, the base table is not disturbed and locked when a single row must be added to the base table. Instead, this invention allows for multiple rows (in fact, an entire table if necessary) to be loaded to a base table without the locking or delay that occurs when individual or multiple rows are added directly to the base table by first adding all of the documents to a global temporary table. The documents from the global temporary table may then be added, in its entirety to the designated base table.

Once the insert application 258 inserts or loads the data from the global temporary table to the base table, the insert application 258 again utilizes the activity monitoring system to check for errors in the loading process. In this way, the insert application 258 may monitor for Referential Integrity (RI) errors that may have occurred during the final insert of documents from the global temporary table to the destination base table. If the insert application 258 recognizes an RI error and will institute a series of update statements to resolve the error.

Once the insert application 258 has successfully inserted the documents from the global temporary table to the destination base table, the rows of data in the global temporary table are deleted in mass. As such, the data storage 252 within the entity server 208 may be freed up to restart the process using the newly open global temporary table. As such, the insert application 258 may issue a new restart record to restart the process if more documents are to be loaded. In some embodiments, multiple global temporary tables may be loaded within an entity at any given time. As such, simultaneously running a system of inserting data to a global temporary table and loading documents onto an appropriate base table.

In some embodiments, the insert application 258 may utilize the same or similar processes as described above in order to add updates to documents previously stored within the entity. As such, the insert application 258 may be able to identify the document to be updated with the received document and position the new document in such a way to update and delete the prior document.

In the embodiments illustrated in FIG. 3 and described throughout much of this specification, the presentment application 256 allows for identification of a user 202 associated with a document loaded, notification and presentment of that document to a user 202, hiding and un-hiding of documents, and receive communications regarding user 202 requests for documents.

In some embodiments, the presentment application 256 identifies a user 202 associated with a document loaded. In this way, the presentment application 256 may identify an account, transaction, or the like associated with the document. Subsequently, the presentment application 256 may identify the user 202 associated with that account, transaction, or the like that generated the document.

Once the user 202 is identified, the presentment application 256 may determine the user's contact information. This contact information may be an email address and/or an online account that the user 202 maintains with the entity.

In some embodiments, the presentment application 256 may then provide notification of documents availability for a user 202 to review via the user 202 contact information. As such the presentment application 256 may communicate via the network 201 to the user 202 through the user system 204. In this way, the presentment application 256 may provide a notification to the user 202, the notification indicates that the entity has processed and stored the document and it is now available for the user 202 to access and review.

In some embodiments, the presentment application 256 may present the document to the user 202. In some embodiments, this may be done by the presentment application 256 sending an email communication to the user 202 of the document. In some embodiments, this may be done by the presentment application 256 presenting the document to the user 202 via the user's online banking application. In this way, when the user 202 logs into his/her online banking, the user 202 may be presented with the documents that the entity server 208 has processed.

As such, once the documents are stored on the destination database, the presentment application 256 may allow the user 202 to have access to his/her documents for viewing. In some embodiments, prior to providing the documents for user view, the system may provide the user with an indication of when the document will be available for review. Furthermore, the system may allow the user to request documents be available for review. If a user requests a document that is not yet stored, the system may expedite the loading and presentment of that document.

In some embodiments, once the system loads the document onto the destination database the user may have access to his/her document. In this way, the system may send a notification to the user that the document is available for viewing. In some embodiments, the document may be sent to the user directly via his/her email or the like. In other embodiments, the document may be presented to a user via his/her online banking application. In this way, once the document is loaded the document may be transferred through the entity's mainframe in order to be communicated to the user.

In some embodiments, the presentment application 256 may allow for hiding or un-hiding of documents. In some embodiments, the system has the ability to hide or unhide documents or files from users 202. In this way, after a document is loaded onto the destination base table, the system may determine to hide the document or file from the user 202. As such, the presentment application 256 may hide the document from the user 202 such that the document is not available for the user 202 to view via online banking application or other electronic communications. In other embodiments, the presentment application 256 may further hide documents or files that were previously viewable by a user 202. In this way, if the document is out of date, needs updating, is inaccurate, or the like, the presentment application 256 may be able hide a document from view that was previously viewable by the user 202. Furthermore, in some embodiments, once a document is hidden from user 202 view, the presentment application 256 may unhide the document.

In some embodiments, the presentment application 256 may receive communications from a user 202 requesting documents. As such, a user 202 may through the user system 204 request one or more documents from the entity. Upon receiving a request for a specific document from a user 202, the presentment application 256 may identify the request and monitor the documents received from the one or more sources. When the requested document is loaded onto a destination table, the presentment application 256 will notify the user 202 immediately. In some embodiments, the presentment application 256 may expedite the processing and loading of the requested document. As such, in this way the presentment application 256 may request the document from the one or more sources, such that the sources will know when a user 202 requests a document. As such, the source may expedite creating and providing the document to the entity server 208.

As illustrated in FIG. 3, the database indexing server 206 generally comprises a communication device 236, a processing device 238, and a memory device 240. The processing device 238 is operatively coupled to the communication device 236 and the memory device 240. The processing device 238 uses the communication device 236 to communicate with the network 201 and other devices on the network 201, such as, but not limited to the entity server 208, the source system 210, and the user system 204. As such, the communication device 236 generally comprises a modem, server, or other device for communicating with other devices on the network 201.

As further illustrated in FIG. 3, the database indexing server 206 comprises computer-readable instructions 242 stored in the memory device 240, which in one embodiment includes the computer-readable instructions 242 of an indexing application 244. In some embodiments, the memory device 240 includes database storage for storing data related to the indexing application 244 including but not limited to data created and/or used by the indexing application 244.

In the embodiments illustrated in FIG. 3 and described throughout much of this specification, the indexing application 244 allows for creation of global temporary tables, removing documents from used global temporary tables for reuse, storage of base tables, and monitoring of tables and the process utilizing the activity monitoring system.

In some embodiments the indexing application 244 creates global temporary tables for insertion of documents for loading in partitions. A global temporary table may be a table that is visible to all sessions but the data in the table is only visible to the session that inserts the documents into the table. In some embodiments, the entity, via the entity server 208 may be able to access the indexing application 244 and set the amount of rows or a multiple amount of rows associated with the global temporary table. In other embodiments, the database indexing server 206 determines the number of rows based on the amount of data received for loading or updating on a base table. In some embodiments, partitioning may be done such that loading on the global temporary table may occur at one or more locations within the table at the same time. In some embodiments, the global temporary table may have the capabilities to accept and stage multi-row insert of documents. The global temporary table may also be a table such as a relational database table or flat file database table. These tables include sets of data values that are organized into columns and rows. Tables typically have a specified number of columns, but rows may vary. Each row may be identified by the values appearing in a particular column subset with may be identified as a unique key index. In this way, the tables may provide for indexing of data that is searchable and accessible to any individual within the entity.

In some embodiments the indexing application 244 may remove the documents from a global temporary table in mass, such that the global temporary table may be reused and reprogrammed for subsequent loads and updates. As such, the indexing application 244 may make sure that all of the documents has been placed into a base table and is accurately placed therein utilizing the activity monitoring system. Once determined, the indexing application 244 will delete the documents on the global temporary table such that it can be reused if necessary.

In some embodiments, the indexing application 244 may provide for entity storage and indexing functionality of documents for the base tables associated with the entity. As such, the indexing application 244 stores, within the memory device 240 the base tables for the entity. Furthermore, the indexing application 244 authorizes and allows access to the documents on the base tables. In this way, the indexing application 244 may authorize a user 202 or vendor to access documents or deny that user 202 or vendor access based on predetermined access criteria. Specifically, the indexing application 244 may allow access to the documents based on user 202 contact information and/or user 202 online banking application. In this way, the indexing application 244 allows for access to and searching of user 202 documents on the based tables and global temporary tables based on user 202 authorization. In this way, the documents may be indexed by the indexing application 244 such that it is searchable for an individual or user 202 associated with the entity to easily access the documents associated with the user 202 and retrieve it.

The indexing application 244 may, in some embodiments, monitor the tables on the database via the activity monitoring system. This monitoring may include monitoring documents for updates, monitoring for user 202 access, security functions such as monitoring for security breaches or unauthorized access to the documents.

FIG. 3 also illustrates a user system 204. The user system 204 is operatively coupled to the entity server 208, source system 210, and/or the database indexing server 206 through the network 201. The user system 204 has systems with devices the same or similar to the devices described for the entity server 208 and/or the database indexing server 206 (e.g., communication device, processing device, and memory device). Therefore, the user system 204 may communicate with the entity server 208, source systems 210, and/or the database indexing server 206 in the same or similar way as previously described with respect to each system. The user system 204, in some embodiments, is comprised of systems and devices that allow for a user 202 to request documents, receive notifications of documents, and view presented documents. A “user device” 204 may be any mobile or computer communication device, such as a cellular telecommunications device (e.g., a cell phone or mobile phone), personal digital assistant (PDA), a mobile Internet accessing device, or other mobile device including, but not limited to portable digital assistants (PDAs), pagers, mobile televisions, gaming devices, laptop computers, desktop computers, cameras, video recorders, audio/video player, radio, GPS devices, any combination of the aforementioned, or the like. Although only a single user system 204 is depicted in FIG. 3, the system environment 200 may contain numerous user systems 204, as appreciated by one of ordinary skill in the art.

FIG. 3 also illustrates a source system 210. The source system 210 is operatively coupled to the entity server 208, user system 204, and/or the database indexing server 206 through the network 201. The source system 210 has systems with devices the same or similar to the devices described for the entity server 208 and/or the database indexing server 206 (e.g., communication device, processing device, and memory device). Therefore, the source system 210 may communicate with the entity server 208, user system 204, and/or the database indexing server 206 in the same or similar way as previously described with respect to each system. The source system 210, in some embodiments, is comprised of systems and devices that allow for sending documents to the entity server 208. In some embodiments, the source systems 210 may also generate the documents based on user 202 interaction with that source. The source system 210 may take the generated document and provide it over the network 201 to the entity server 208. The source systems 210 are associated with the entity. In this way, the source systems 210 are lines of business, groups, subsidiaries, business partners, or the like associated with the entity.

FIG. 3 depicts only one source system 210 within the computing system environment 200, however, one of ordinary skill in the art will appreciate that a plurality of source systems 210 may be communicably linked with the network 201 and the other devices on connected to the network 201, such that each source system 210 is communicably linked to the network 201 and the other devices on the network 201.

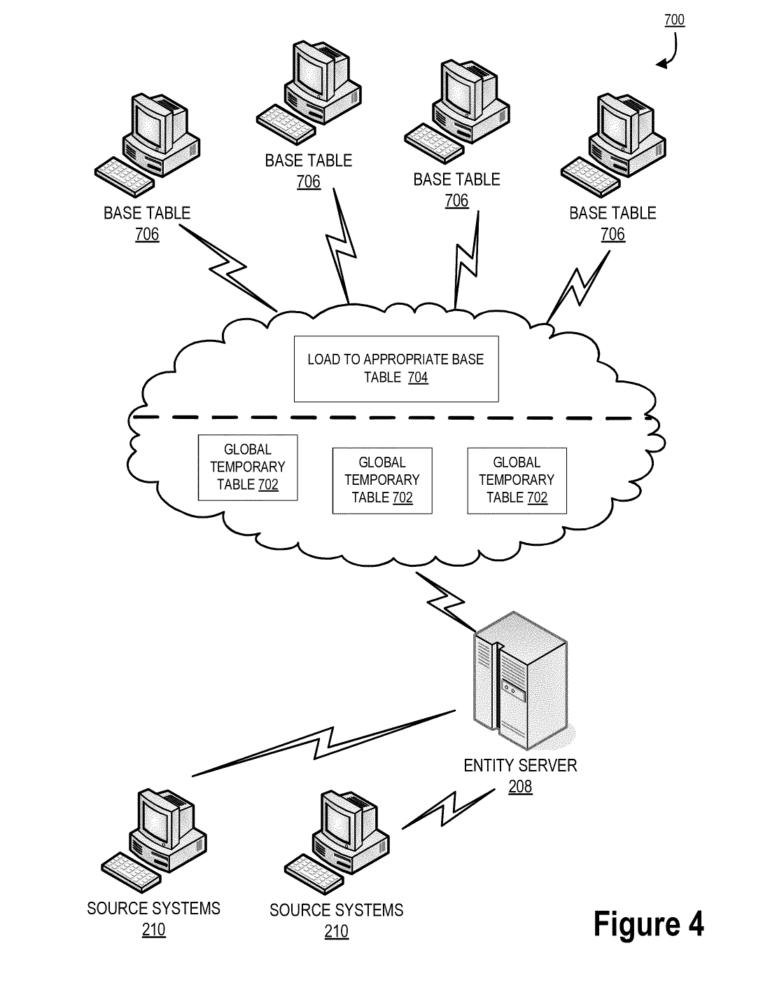

FIG. 4 illustrates a flow of data through the system for loading and updating documents 700, in accordance with an embodiment of the invention. The documents may be received at the entity system 208 from one or more source systems 210. In some embodiments, the documents may be financial institution documents associated with a user 202, based on user 202 interaction with the source. Financial institution documents may include documents associated with one or more of account information, transaction information, or other financial data associated financial institutions.

Next, once the entity server 208 receives the documents from one or more source systems 210 the entity server 208 may, in coordination with the database indexing server 206 direct the documents to the appropriate base table 706. Once the documents are identified and the appropriate base table 706 is identified, the entity server 208 may direct the documents to an appropriate global temporary table 702. In this example, the entity server 208 may direct the load or update data to one of three global temporary table 702. As such, in this example the entity server 208 may direct the documents to one of the three global temporary tables 702 depending on the base table that the data may be directed to.

As illustrated in block 704, the system may then load the documents to the appropriate base table 706. In some embodiments, the system may load the documents to the appropriate base table 706 when the global temporary table 702 has been filled with partition insertions of the documents for loading or updating. As such, the system may direct the documents from the appropriate global temporary table 702 to the appropriate base table 706 such that the base table 706 may be loaded or updated with the appropriate documents.

FIG. 5 illustrates the partition loading of document for enterprise workflow applications 900, in accordance with embodiments of the invention. The documents may be divided into one or more jobs or batches of documents. In some embodiments, the jobs may be based on the source of the documents. In some embodiments, the jobs may be based on the order in which the documents are received (timing of receiving the documents). In the embodiment illustrated in FIG. 5, Job 1 902, Job 2 904, Job 3 906, and Job N 908 are illustrated. In this way there may be one or more jobs at any given time. These jobs or batches will be directed into the same global temporary table 702. However, each job will be directed to a different partition of the global temporary table 702. In the embodiment illustrated in FIG. 5, Partition 1 910, Partition 2 912, Partition 3 914, Partition 4 916, and Partition N are illustrated. In this way, the system may device the global temporary table 702 into one or multiple partitions for loading of documents. As such, each job of documents may be loaded into the global temporary table at one or more partitions as the same time. In some embodiments, one job will be loaded into one partition. In other embodiments, multiple jobs will be loaded into one partition.

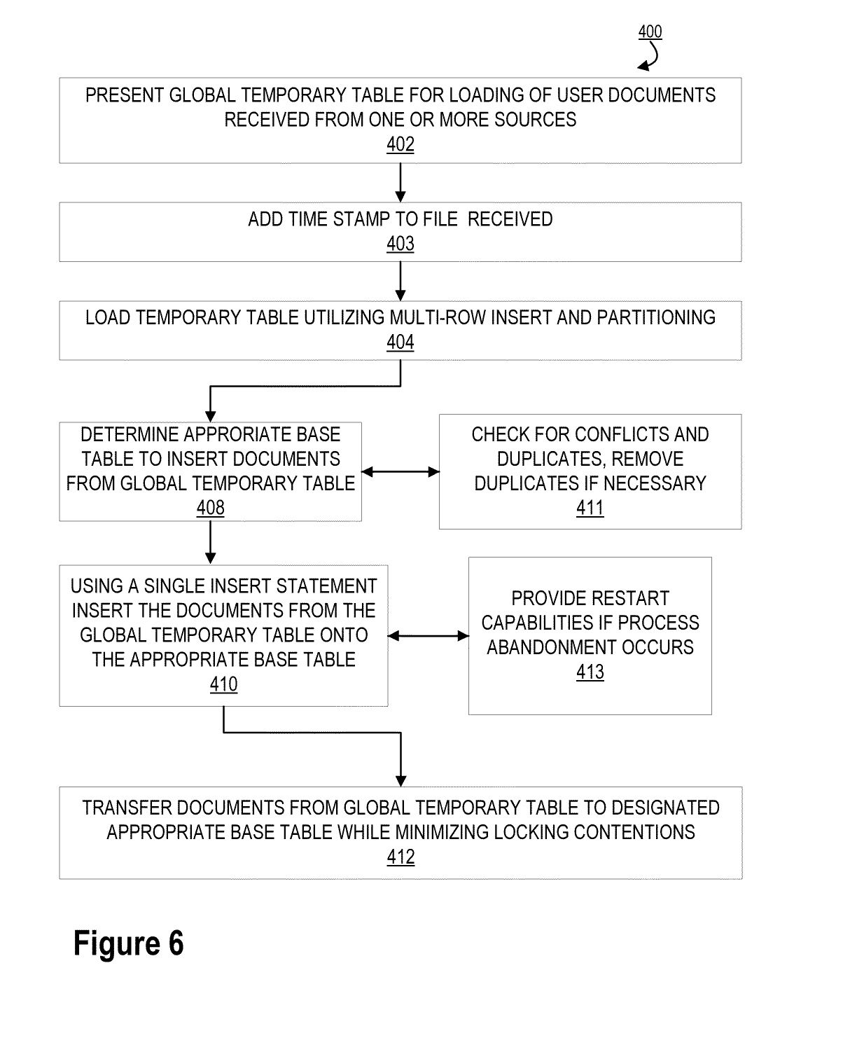

FIG. 6 illustrates a detailed decision process flow for the process of document loading for enterprise workflow applications 400, in accordance with embodiments of the invention. As illustrated in block 402, the system presents a global temporary table for loading documents received from the one or more sources, for insertion or data load into a base table. As illustrated in block 403, the system may then add a time stamp to the file name of each user document received. Next, as illustrated in block 404, the system loads the temporary table with the documents for insertion into destination tables in a database. The loading utilizing multi-row insert and/or partitioning functionality.

At this point, the documents do not have to be logged, which is typically required when loading data using multi-row insert. Instead, by using a global temporary table, the documents being loaded via partitioning are not logged. Next, as illustrated in block 408, the appropriate base table to insert the documents from the global temporary table is determined. In some embodiments, the system may determine the appropriate base table. In other embodiments, the entity may determine the appropriate base table. In yet other embodiments, the appropriate base table is determined by the documents loaded on the global temporary table. When determining the appropriate base table, the system may check for conflicts and duplicates associated with the documents loaded onto the global temporary table using the activity monitoring system, as illustrated in block 411. If a duplicate or conflict is determined, then the system rectifies the duplicate or conflict.

As illustrated in block 410 of FIG. 6, using a single insert statement the system may insert the documents from the global temporary table onto the appropriate base table. Once inserted, the system may provide restart capabilities to the process if process abandonment occurs utilizing the activity monitoring system, as illustrated in block 413. Finally, as illustrated in block 412, the documents are transferred from the global temporary table to the designated appropriate base table while minimizing locking contentions that may arise. If other errors occur at final insertion, such as Referential Integrity (RI) errors or the like, the system may also provide for update statements to resolve the error.

This process 400 provides several key components and performance benefits over traditional table loading processes. First, the internal global temporary tables are created at insert program startups and are not logged by the database system. As such, this improves the singleton insert processing. Next, the load data is validated by the program during insert to the global temporary table. In this way, the process 400 thereby eliminates locks that are normally held on the destination table, as described above in block 412. Furthermore, the final insert process is optimized by writing global temporary table rows to a contiguous area of the destination base table when defined without any free space. As such, the entire area of destination base table may be filled using the documents from the global temporary table. Thus loading large amount of data into a contiguous area on the base table quickly and effectively.

Furthermore, the single insertion statement that inserts the documents from the global temporary table onto the appropriate base table, as described about in block 410, is tuned by altering the unit of work size to optimize the documents and workload characteristics. The process minimizes locking contentions (illustrated in block 412) by locking on destination tables at the very end of each unit of work. In this way the process minimizes the locking contentions with other read/write activity.

As described above, if errors such as Referential Integrity (RI) errors occur the system may also provide for update statements to resolve the error utilizing the activity monitoring system. However, in the process 400 RI errors only occur during final insert. There are only two types that may occur, including key duplicates and true duplicates. Key duplicates occur when a unique key from the base table is present on the global temporary table. True duplicates occur when an entire row from the base table is present on the global temporary table. These RI errors may be corrected in the process 400. Key duplicates are resolved using a single update statement against the global temporary table using SQL existence sub-select from the base table. True duplicates are resolved via a single update statement marking all duplicate rows in the global temporary tables as obsolete using a SQL existence sub-select from the base table. Finally, RI duplicates can be prevented within a unit of work by presorting the input data and defining a unique index on the global temporary table that matches the unique key of the base table.

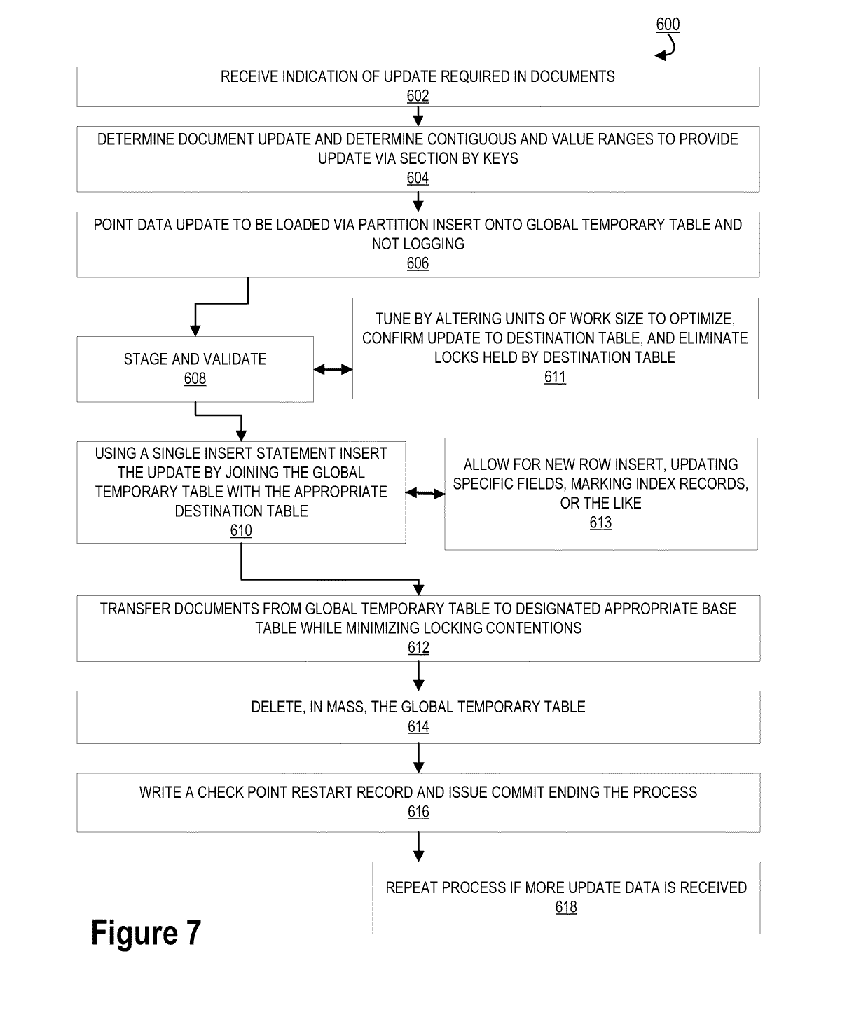

FIG. 7 illustrates a detailed process of updating documents for enterprise workflow applications 600, in accordance with embodiments of the invention. As illustrated in block 602, the system receives an indication of updates required in one or more documents on a base table. Next, as illustrated in block 604, the system may determine documents update and determine contiguous and value ranges to provide the update via sections by keys. Next, the system may point the document update to be loaded to a specific base table via partition insert onto global temporary tables, as illustrated in block 606. At this point, the documents do not have to be logged, which is typically required when updating documents using multi-row insert. Instead, by using a global temporary table, the documents being loaded via partition insert is not logged, as illustrated in block 606. The documents may then be staged and validated on the global temporary table, in anticipation of adding the data to the base table, as illustrated in block 608. The system may tune the staging and validation by altering units of work size to optimizes confirm updated to destination table, as illustrated in block 611. Thus eliminating locking that may occur when uploading update data to the designated base table. This may be done utilizing the activity monitoring system of the process 600.

Using a single insert statement insert, the system may insert the update documents by joining the global temporary table with the appropriate destination table, as illustrated in block 610. The system update documents may also allow for new row insertion, updating specific fields, marking index records, or the like, as illustrated in block 613.

As illustrated in block 612, the update documents are transferred from the global temporary table to the appropriate base table, based on the update documents. This transfer minimizes locking contentions, as described above with respect to block 611. Once the transfer of the documents is complete, the documents on the global temporary table are deleted in mass, as illustrated in block 614. A check point restart record is written and an issue commit ending the process is activated, as illustrated in block 616. Finally, the process may be repeated if more update data is received and needs to be implemented onto a base table, as illustrated in block 618.

This process 600 provides several key components and performance benefits over traditional table updating processes. First, the internal global temporary tables are created at the update program start up and are not logged by the database system, as illustrated in block 606. As such this improves the singleton insert processing. Next, the update documents is validated by the program during insert to the global temporary table. In this way, the process 600 thereby eliminates locks that are normally held on the destination table, as described above in block 611. Furthermore, the single insertion statement that inserts the update documents from the global temporary table onto the appropriate base table, as described about in block 612, is tuned by altering the unit of work size to optimize the documents and workload characteristics. Next, locking on the destination base table is held to the very end of each unit of work processing. As such, minimizing contentions with other read/write activities occurring within the entity's information technology infrastructure. Finally, the update documents may be sorted into the appropriate index order allowing a more continuous update/insert of the base table.

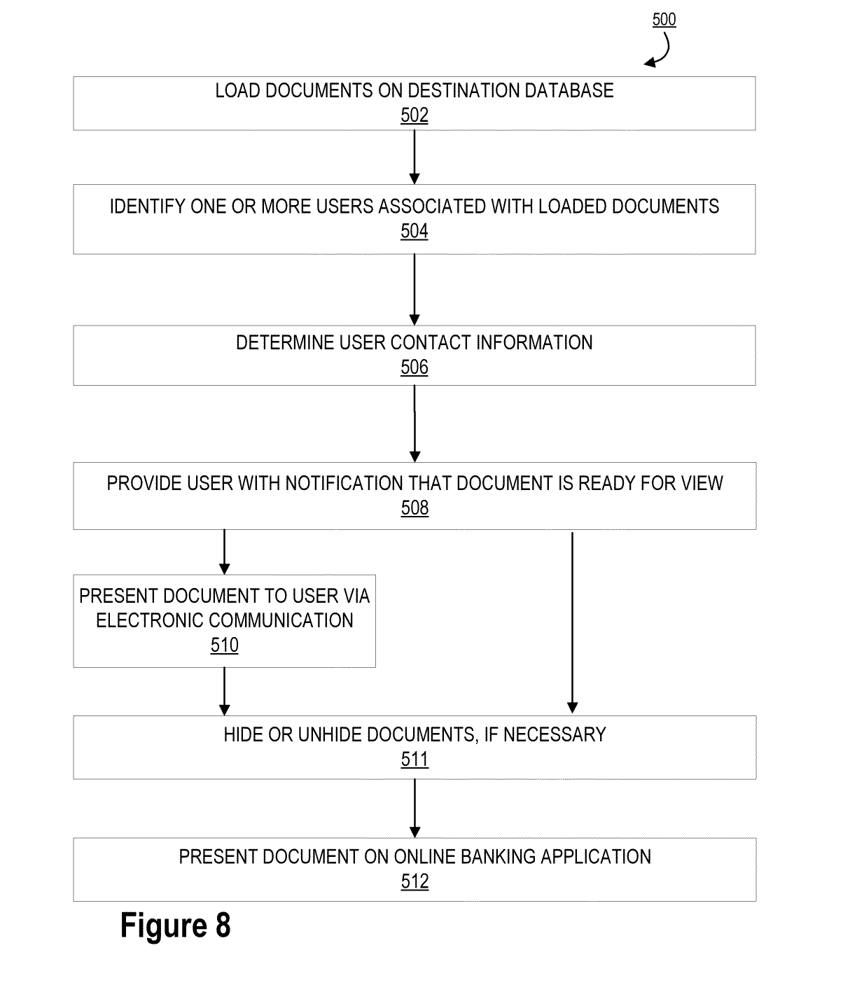

FIG. 8 illustrates a high level process flow for the presentment of documents to a user 500, in accordance with embodiments of the invention. First, as illustrated in block 502, the documents may be loaded on a destination base table. Next, the system may identify one or more users 202 associated with the loaded documents, as illustrated in block 504. As such, for each document that is stored, the system will identify one or more user's associated with each of the documents loaded. Next, as illustrated in block 506, the system may identify the user 202 associated with the document contact information. This contact information may be one or more email account and/or financial institution online banking applications. Once the contact information is determined for the user 202, the system may provide the user 202 with a notification that the document associated with the user 202 is ready for user 202 viewing.

The system may next automatically present to document on the user's online banking application, as illustrated in block 512. However, in some embodiments, the system may provide the user 202 with the documents via an electronic communication, such as an email, text message or the like, as illustrated in block 510.

As illustrated in block 511, the system may also be allowed to hide or unhide documents if the system determines it to be necessary. In some embodiments, the document may be hidden immediately upon loading onto the destination table, such that a user 202 may not be able to visualize the document. In other embodiments, the system may hide a document after it has been previously viewable by a user 202. In this way, if the document is out of date, needs updating, is inaccurate, or the like, the system may be able to store the document but subsequently hide the document from view. Furthermore, in some embodiments, once a document is hidden from user view, the system may unhide the document as well.

After the document has been provided to the user 202 via electronic communications, as illustrated in block 510, the system may also present the documents on the user's online banking application, as illustrated in block 512.

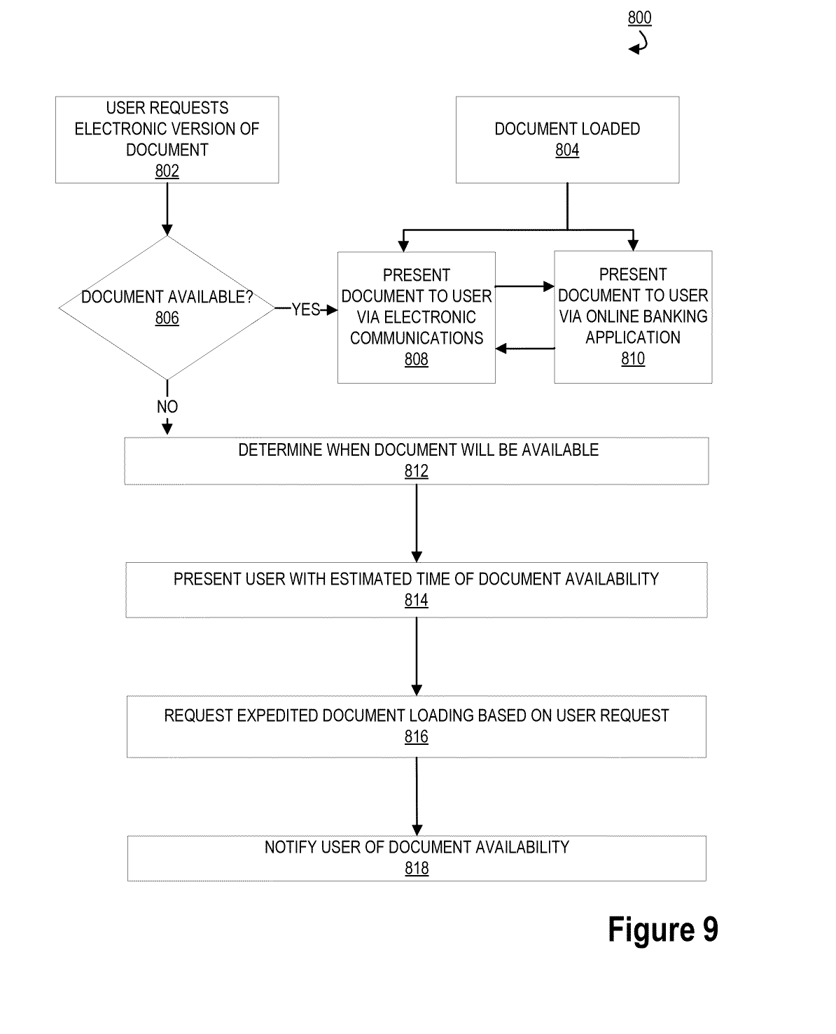

FIG. 9 illustrates a high level decision process flow for a user 202 request for documents 800, in accordance with embodiments of the invention. As illustrated in block 802, the system identified a user 202 request for electronic versions of a document. This request may come be directed to the entity or to the source of the document. The request may be received electronically, such as through a website request, email, text, or the like. Once the request is received, the system determines if the document is available yet, as illustrated in decision block 806. The document is available if it has been loaded into the final database. The document is not yet available if the system hasn't received the document from the source or hasn't finalized the loading of the document onto the destination table.

If the system determines that the requested document from block 802 is available in decision block 806, the system will either present the document to the user 202 via an electronic communication, as illustrated in block 808 or present document to user 202 via online banking application 810. In some embodiments, presenting the documents to the user 202 through electronic communication, as illustrated in block 808 comprises sending correspondence to the user's contact information, such as an email, text message, voice communications, or the like. In some embodiments, presenting the documents to a user 202 via online banking application 810 includes importing the documents into the user's online banking or mobile banking application and providing the user 202 with a notification that the documents have been imported to his/her online banking application for viewing.

In some embodiments, the documents may be loaded without the user 202 requesting the documents, as illustrated in block 804. In this way, the system may either present the documents to the user via electronic communications, as illustrated in block 808 or present the documents to the user via online banking application, as illustrated in block 810. In this way, as soon as a document is available, irrespective of the user 202 requesting the document, it will be posted to the user's online banking application portal or be sent to the user 202 via electronic communications.

If at decision block 806, the system determines that the documents requested by the user 202 in block 802 are not available, the system will determine when the documents will be available, as illustrated in block 812. In some embodiments, the system will determine that the documents are in the process of being stored and presented. In some embodiments, the system will determine that the document have not been received from the source. As such, the system may communicate with the one or more sources of the documents to determine when the documents will be provided to the system.

Once the system determines the location of the document and determines when the documents will be available, the system may present the user 202 with an estimated time of document availability, as illustrated in block 814. As such, the system may provide a communication to the user 202 of the predicted time of availability. In some embodiments, this may be an electronic communication or through the user's online banking application.

Next, as illustrated in block 816, the system may request expedited document loading based on the user 202 request for an electronic version of one or more user 202 documents, in block 802. As such, the system may communicate with one or more sources within the entity to expedite a document that the user 202 may require or request.

Finally, after expediting the document in block 816, the system will provide the user with a notification as soon as the expedited document is available for the user's review, as illustrated in block 818.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, or the like), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational phases to be performed on the computer or other programmable apparatus to produce a computer-implemented process such that the code portions which execute on the computer or other programmable apparatus provide phases for implementing the functions/acts specified in the flowchart and/or block diagram block(s). Alternatively, computer program implemented phases or acts may be combined with operator or human implemented phases or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that phases of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for user document indexing and presentment, the system comprising:
a memory device with computer-readable program code stored thereon;
a communication device;
a processing device operatively coupled to the memory device and the communication device, wherein the processing device is configured to execute the computer-readable program code to:
receive documents for storage on the entity database, wherein the documents are received from a source within the entity, wherein the documents are created by the source based on an interaction between the entity and the user;
present a temporary table to store the received documents;
insert the received documents onto the temporary table, wherein the insertion of the received data is done by partition insertion;
stage the temporary table comprising the received documents;
insert the received documents from the temporary table to an appropriate base table, wherein the insertion of all the documents on the temporary table is completed using a single insert statement;
identify the user associated with each of the documents inserted on the appropriate base table; and
notify the user associated with each of the documents inserted on the appropriate base table that the documents have been inserted on the appropriate base table.

2. The system of claim 1 further comprising presenting one or more documents associated with the user to the user, wherein presenting the one or more documents comprises electronically communicating the document to the user or providing the one or more documents to an online banking application associated with the user.

3. The system of claim 1 further comprising confirming providing activity monitoring, wherein the activity monitoring monitors to ensure that the received documents are inserted correctly on the appropriate base table.

4. The system of claim 1 further comprising deleting, in mass, the received documents from the temporary table based at least in part on the confirming that the received documents are inserted correctly on the appropriate base table.

5. The system of claim 1, wherein the documents are generated by sources within the entity for presentment to the user, wherein the documents are generated based at least in part on financial institution accounts corresponding to the user that the entity maintains.

6. The system of claim 1, wherein partition insertion further comprises inserting one or more batches of documents into the temporary table at the same time.

7. The system of claim 1, wherein the temporary table is a global temporary table or in-memory database table that is internal to the entity, wherein the temporary table is created at an initiation of receiving documents to insert on a base table within the entity database, wherein the temporary table is not logged by the entity database.

8. The system of claim 1, wherein inserting the received documents from the temporary table to the appropriate base table further comprises inserting the received documents to the appropriate base table in mass, wherein the mass data insert reduces locking contentions.

9. The system of claim 1 further comprising hiding the documents inserted on the appropriate base table from the user, wherein hiding the documents comprises not allowing the user to view the documents, wherein the hiding is reversible.

10. A computer program product for user document indexing and presentment, the computer program product comprising at least one non-transitory computer-readable medium having computer-readable program code portions embodied therein, the computer-readable program code portions comprising:
an executable portion configured for receiving documents for storage on the entity database, wherein the documents are received from a source within the entity, wherein the documents are created by the source based on an interaction between the entity and the user;
an executable portion configured for presenting a temporary table to store the received documents;
an executable portion configured for inserting the received documents onto the temporary table, wherein the insertion of the received data is done by partition insertion;
an executable portion configured for staging the temporary table comprising the received documents;
an executable portion configured for inserting the received documents from the temporary table to an appropriate base table, wherein the insertion of all the documents on the temporary table is completed using a single insert statement;
an executable portion configured for identifying the user associated with each of the documents inserted on the appropriate base table; and
an executable portion configured for notifying the user associated with each of the documents inserted on the appropriate base table that the documents have been inserted on the appropriate base table.

11. The computer program product of claim 10 further comprising an executable portion configured for presenting one or more documents associated with the user to the user, wherein presenting the one or more documents comprises electronically communicating the document to the user or providing the one or more documents to an online banking application associated with the user.

12. The computer program product of claim 10 further comprising an executable portion configured for confirming providing activity monitoring, wherein the activity monitoring monitors to ensure that the received documents are inserted correctly on the appropriate base table.

13. The computer program product of claim 10 further comprising an executable portion configured for deleting, in mass, the received documents from the temporary table based at least in part on the confirming that the received documents are inserted correctly on the appropriate base table.

14. The computer program product of claim 10, wherein the documents are generated by sources within the entity for presentment to the user, wherein the documents are generated based at least in part on financial institution accounts corresponding to the user that the entity maintains.

15. The computer program product of claim 10, wherein partition insertion further comprises inserting one or more batches of documents into the temporary table at the same time.

16. The computer program product of claim 10, wherein the temporary table is a global temporary table or in-memory database table that is internal to the entity, wherein the temporary table is created at an initiation of receiving documents to insert on a base table within the entity database, wherein the temporary table is not logged by the entity database.

17. The computer program product of claim 10, wherein inserting the received documents from the temporary table to the appropriate base table further comprises inserting the received documents to the appropriate base table in mass, wherein the mass data insert reduces locking contentions.

18. A computer-implemented method for user document indexing and presentment, the method comprising:
providing a computing system comprising a computer processing device and a non-transitory computer readable medium, where the computer readable medium comprises configured computer program instruction code, such that when said instruction code is operated by said computer processing device, said computer processing device performs the following operations:
receiving documents for storage on the entity database, wherein the documents are received from a source within the entity, wherein the documents are created by the source based on an interaction between the entity and the user;
presenting a temporary table to store the received documents;
inserting, via a computer device processor, the received documents onto the temporary table, wherein the insertion of the received data is done by partition insertion;
staging the temporary table comprising the received documents;
inserting the received documents from the temporary table to an appropriate base table, wherein the insertion of all the documents on the temporary table is completed using a single insert statement;
identifying the user associated with each of the documents inserted on the appropriate base table; and
notifying the user associated with each of the documents inserted on the appropriate base table that the documents have been inserted on the appropriate base table.

19. The computer-implemented method of claim 18 further comprising presenting one or more documents associated with the user to the user, wherein presenting the one or more documents comprises electronically communicating the document to the user or providing the one or more documents to an online banking application associated with the user.

20. The computer-implemented method of claim 18 further comprising confirming providing activity monitoring, wherein the activity monitoring monitors to ensure that the received documents are inserted correctly on the appropriate base table.

21. The computer-implemented method of claim 18 further comprising deleting, in mass, the received documents from the temporary table based at least in part on the confirming that the received documents are inserted correctly on the appropriate base table.

22. The computer-implemented method of claim 18, wherein the documents are generated by sources within the entity for presentment to the user, wherein the documents are generated based at least in part on financial institution accounts corresponding to the user that the entity maintains.

23. The computer-implemented method of claim 18, wherein partition insertion further comprises inserting one or more batches of documents into the temporary table at the same time.
